(19) United States
(12) Patent Application Publication
(10) Pub. No.: US 2011/0200902 A1
(43) Pub. Date: Aug. 18, 2011

(54) FUEL CELL SYSTEM AND FUEL CELL STATE DETECTION METHOD

(75) Inventor: Yasushi Araki, Shizuoka-ken (JP)

(73) Assignee: TOYOTA JIDOSHA KABUSHIKI KAISHA, Toyota-shi, Aichi-ken (JP)

(21) Appl. No.: 13/125,374

(22) PCT Filed: Oct. 27, 2009
(86) PCT No.: PCT/IB09/07240

§ 371 Date: Apr. 21, 2011

(30) Foreign Application Priority Data
Oct. 28, 2008 (JP) 2008-277213

(51) Int. Cl. H01M 8/04

(52) U.S. Cl. 429/432

(57) ABSTRACT

A fuel cell system (100) includes: a fuel cell stack (10) formed by stacking a plurality of call groups each of which includes at least one cell (11); voltage detection units (41) that detect cell group voltages of the respective cell groups; and a determination unit (52) that determines whether the cell group voltage of a determination-target cell group that is selected from among the plurality of cell groups is equal to or lower than the threshold voltage that is obtained based on the average value and the standard deviation of the cell group voltages of the cell groups in a population that is formed of at least two of the cell groups selected from among the plurality of cell groups.

### BACKGROUND OF THE INVENTION

1. Field of the Invention

The invention relates to a fuel cell system and a fuel cell state detection method.

2. Description of the Related Art

Generally, fuel cells produce electric energy by using hydrogen and oxygen as fuel. Fuel cells have been widely developed as future energy supply systems because they are environmentally friendly and exhibit high energy efficiency. Especially, polymer electrolyte fuel cells have good startability because the temperature at which the polymer electrolyte fuel cells are actuated is lower than the temperatures at which various other fuel cells are actuated. Therefore, a lot of research has been made to place the polymer electrolyte fuel cells into practical use in various fields.

A polymer electrolyte fuel cell has a structure in which a membrane electrode assembly (MEA) is held between separators. In the MEA, an anode is provided on one side of an electrolyte membrane, which is formed of a proton conductive polymer electrolyte, and a cathode is provided on the other side of the electrolyte membrane.

The state of the fuel cell varies depending on, for example, the operating condition. Therefore, for example, Japanese Patent Application Publication No. 2006-179338 (JP-A-2006-179338) describes a technology for monitoring whether there is a drop in each cell group voltage, which is the detected voltage of a cell group, in a fuel cell stack that is formed by stacking multiple fuel cells.

However, with the technology described in JP-A-2006-179338, it is difficult to distinguish normally operating cells and malfunctioning cells from each other.

### SUMMARY OF THE INVENTION

The invention provides a fuel cell system and a fuel cell state detection method with which a cell where a malfunction has occurred or a malfunction is about to occur is detected easily.

A first aspect of the invention relates to a fuel cell system which includes: a fuel cell stack that is formed by stacking a plurality of cell groups each of which includes at least one cell; voltage detection units that detect cell group voltages of the respective cell groups; and a determination unit that determines whether the cell group voltage of a determination-target cell group that is selected from among the plurality of cell groups is equal to or lower than a threshold voltage that is obtained based on the average value and the standard deviation of the cell group voltages of the cell groups in a population that is formed of at least two of the cell groups among the plurality of cell groups.

In the fuel cell system according to the first aspect of the invention, it is determined whether the determination-target cell group has an eccentric cell group voltage in the normal distribution of the cell group voltages of the cell groups that constitute the population and that are included in the fuel cell stack. In this case, it is possible to easily detect the cell group in which a malfunction has occurred or a malfunction is about to occur.

The fuel cell system according to the first aspect of the invention may include a control unit that controls the fuel cell system. If the determination unit determines that the cell group voltage of the determination-target cell group is equal to or lower than the threshold voltage, the control unit may determine that a malfunction has occurred or a malfunction is about to occur in the determination-target cell group.

The determination-target cell group may have the cell group voltage that is equal to or lower than the average value of the cell group voltages of the plurality of cell groups. In this case, it is possible to detect the cell group that has an eccentrically low cell group voltage in the normal distribution of the cell group voltages of the cell groups that constitute the population and that are included in the fuel cell stack. Thus, it is possible to easily detect the cell group in which a malfunction has occurred or a malfunction is about to occur. The determination-target cell group may have the lowest cell group voltage among the plurality of cell groups.

The population need not include the determination-target cell group. In this case, it is possible to improve the reliability of the population. The threshold voltage may be the lower limit of a predetermined range centered at the average value of the cell group voltages of the cell groups in the population, the predetermined range being determined based on the normal distribution of the cell group voltages of the cell groups in the population. In this case, it is possible to detect the cell group that has an eccentrically low cell group voltage in the normal distribution of the cell group voltages of the cell groups in the population.

The determination unit may exclude the cell group having the cell group voltage equal to or lower than a predetermined cell group voltage from the population. In this case, it is possible to improve the reliability of the population. The determination unit may exclude, from the population, the cell group having the cell group voltage equal to or lower than a lower limit of a predetermined range centered at the average value of the cell group voltages of the cell groups in the population, the predetermined range being determined based on the normal distribution of the cell group voltages of the cell groups in the population. In this case, it is possible to improve the reliability of the population.

A second aspect of the invention relates to a method for detecting a state of a fuel cell that is formed by stacking a plurality of cell groups each of which includes at least one cell. According to the method, cell group voltages of the respective cell groups are detected, and it is determined whether the cell group voltage of a determination-target cell group that is selected from among the plurality of cell groups is equal to or lower than a threshold voltage that is obtained based on the average value and the standard deviation of the cell group voltages of the cell groups in a population that is formed of at least two of the cell groups among the plurality of cell groups.

According to the method described above, it is determined whether the determination-target cell group has an eccentric cell group voltage in the normal distribution of the cell group voltages of the cell groups in the population. In this case, it is possible to easily detect the cell group in which a malfunction has occurred or a malfunction is about to occur.

The determination-target cell group may have the cell group voltage that is equal to or lower than the average value of the cell group voltages of the plurality of cell groups. In this case, it is possible to detect the cell group that has an eccentrically low cell group voltage in the normal distribution of the cell group voltages of the cell groups in the population. Thus, it is possible to easily detect the cell group in which a malfunction has occurred or a malfunction is about to occur. The determination-target cell group may have the lowest cell group voltage among the plurality of cell groups.

The population need not include the determination-target cell group. In this case, it is possible to improve the reliability of the population. The threshold voltage may be the lower limit of a predetermined range centered at the average value of the cell group voltages of the cell groups in the population, the predetermined range being determined based on a normal distribution of the cell group voltages of the cell groups in the population. In this case, it is possible to detect the cell group that has an eccentrically low cell group voltage in the normal distribution of the cell group voltages of the cell groups in the population.

The cell group having the cell group voltage equal to or lower than a predetermined cell group voltage may be excluded from the population. In this case, it is possible to improve the reliability of the population. The cell group having the cell group voltage equal to or lower than a lower limit of a predetermined range centered at the average value of the cell group voltages of the cell groups in the population may be excluded from the population, the predetermined range being determined based on the normal distribution of the cell group voltages of the cell groups in the population. In this case, it is possible to improve the reliability of the population.

According to the above-described aspects of the invention, it is possible to easily detect the cell in which a malfunction has occurred or a malfunction is about to occur.

### BRIEF DESCRIPTION OF THE DRAWINGS

The foregoing and further objects, features and advantages of the invention will become apparent from the following description of an example embodiment with reference to the accompanying drawings, wherein like numerals are used to represent like elements and wherein:

FIG. 1A and FIG. 1B are views illustrating a fuel cell system according to an embodiment of the invention;

FIG. 2 is a graph illustrating an example of detection results obtained by voltage detection units;

FIG. 3 is a graph illustrating a normal distribution curve of the cell group voltage;

FIG. 4 is an example of a flowchart for determining whether a malfunction has occurred in a determination-target cell group;

FIG. 5 is a graph illustrating the relationship between the standard deviation when the cell voltage of each cell is detected and the standard deviation when the cell group voltage is divided by the number of cells in the cell group;

FIG. 6A and FIG. 6B are graphs illustrating normal distribution curves of the cell group voltage;

FIG. 7A and FIG. 7B are graphs illustrating a change point where the rate, at which the cell group voltage changes with respect to the current density, changes; and

FIG. 8 is an example of a flowchart showing a routine that is executed when cell groups that constitute a statistical population are changed.

### DETAILED DESCRIPTION OF THE EXAMPLE EMBODIMENT

An example embodiment of the invention will be described below.

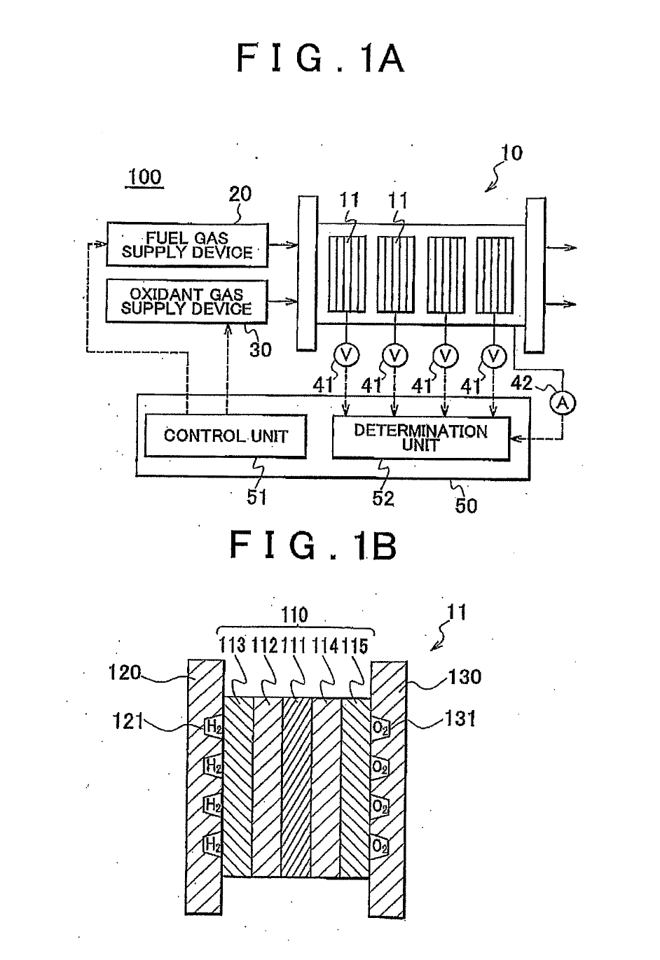

FIG. 1A and FIG. 1B are views illustrating a fuel cell system 100 according to an embodiment of the invention. FIG. 1A is a view schematically showing the overall configuration of the fuel cell system 100. FIG. 1B is a cross-sectional view schematically showing a cell 11, which will be described later in detail. As shown in FIG. 1A, the fuel cell system 100 includes a fuel cell stack 10, a fuel gas supply device 20, an oxidant gas supply device 30, voltage detection units 41, a current detection unit 42, a processing unit 50, etc.

The fuel cell stack 10 includes at least one cell group that is formed of at least one cell 11. As shown in FIG. 1B, the cell 11 has a structure in which a membrane-electrode assembly (MEA) 110 is held between a separator 120 and a separator 130. In the MEA 110, an anode catalytic layer 112 and a gas diffusion layer 113 are arranged between an electrolyte membrane 111 and the separator 120, and a cathode catalytic layer 114 and a gas diffusion layer 115 are arranged between the electrolyte membrane 111 and the separator 130. The electrolyte member 111 is formed of a proton conductive polymer electrolyte, for example, a perfluorosulfonate polymer.

The anode catalytic layer 112 is formed of, for example, a conductive material that supports a catalyst, or a proton conductive electrolyte. The catalyst in the anode catalytic layer 112 is a catalyst that promotes protonation of hydrogen. The anode catalytic layer 112 contains, for example, platinum-supported carbon, or a perfluorosulfonate polymer. The gas diffusion layer 113 is formed of a gas-permeable conductive material, for example, carbon paper, or carbon cloth.

The cathode catalytic layer 114 is formed of, for example, a conductive material that supports a catalyst, or a proton conductive electrolyte. The catalyst in the cathode catalytic layer 114 is a catalyst that promotes reaction between protons and oxygen. The cathode catalytic layer 114 contains, for example, platinum-supported carbon, or a perfluorosulfonate polymer. The gas diffusion layer 115 is formed of a gas-permeable conductive material, for example, carbon paper or carbon cloth.

The separators 120 and 130 are made of a conductive material, for example, stainless steel. A fuel gas passage 121, through which fuel gas flows, is formed in the face of the separator 120, which faces the MEA 110. An oxidant gas passage 131, through which oxidant gas flows, is formed in the face of the separator 130, which faces the MEA 110. The fuel gas passage 121 and the oxidant gas passage 131 are, for example, recesses formed in the faces of the separators 120 and 130, respectively.

The fuel gas supply device 20 supplies fuel gas that contains hydrogen to the fuel gas passage 121 through a fuel gas inlet of the fuel cell stack 10. The fuel gas supply device 20 is, for example, a hydrogen tank or a reformer. The oxidant gas supply device 30 supplies oxidant gas that contains oxygen to the oxygen gas passage 131 through an oxidant gas inlet of the fuel cell stack 10. The oxidant gas supply device 30 is, for example, an air pump.

The voltage detection units 41 detect the cell group voltages of the respective cell groups, and provide the detection results to a control unit 51, which will be described later in detail. The current detection unit 42 detects the electric current generated by the fuel cell stack 10, and provides the detection result to the control unit 51. The density of the generated current is obtained by dividing the electric current detected by the current detection unit 42 by the area of power generation regions of the cells 11. Therefore, the current detection unit 42 may serve also as a generated current density detection unit.

The processing unit 50 includes the control unit 51 and a determination unit 52. The processing unit 50 is formed of a CPU (Central Processing Unit), a ROM (Read Only Memory), a RAM (Random Access Memory), etc. When the CPU of the processing unit 50 executes predetermined programs, the control unit 51 and the determination unit 52 are implemented. The control unit 51 controls various portions of the fuel cell system 100. The determination unit 52 determines the state of the fuel cell stack 10 based on the detection results obtained by the voltage detection units 41 and the current detection unit 42.

Next, the operation of the fuel cell system 100 during normal power generation will be described with reference to FIG. 1A and FIG. 1B. The control unit 51 controls the fuel gas supply device 20 in such a manner that the fuel gas is supplied to the fuel gas passage 121. The fuel gas passes through the gas diffusion layer 113 and reaches the anode catalytic layer 112. The hydrogen contained in the fuel gas is separated into protons and electrons by the catalyst in the anode catalytic layer 112. The protons pass through the electrolyte membrane 111 and reach the cathode catalytic layer 114.

The control unit 51 controls the oxidant gas supply device 30 in such a manner that the oxidant gas is supplied to the oxidant gas passage 131. The oxidant gas passes through the gas diffusion layer 115 and reaches the cathode catalytic layer 114. In the cathode catalytic layer 114, a reaction between protons and oxygen is caused by the catalyst. Thus, electric power is generated and water is produced. The produced water is discharged through the oxidant gas passage 131.

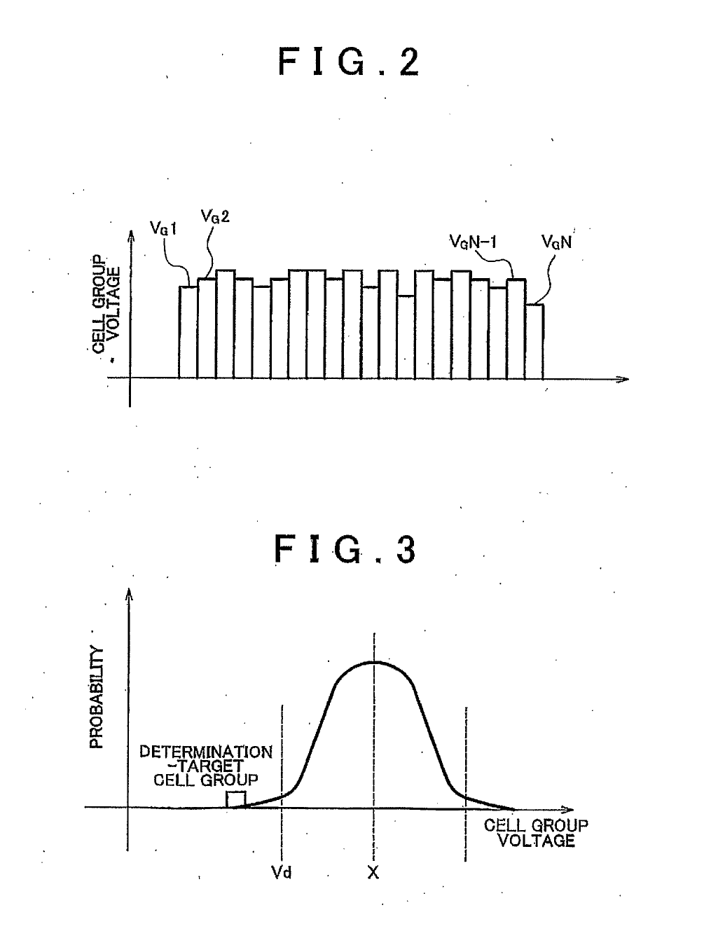

FIG. 2 is a graph illustrating an example of the detection results obtained by the voltage detection units 41. In FIG. 2, the abscissa axis indicates the cell groups, and the ordinate axis indicates the cell group voltage. The number of cells that constitute one cell group is not particularly limited. In the embodiment, the number of cells included in one cell group is around 10. As shown in FIG. 2, there are certain variations among the cell group voltages V_{G}1 to V_{G}N of the cell groups G1 to GN. The variations occur due to, for example, variations in the diffusion of the reaction gas in the cells.

In the cell group that has run out of or is running out of the reaction gas, the cell group voltage is likely to drop. Therefore, the determination unit 52 determines whether the cell group voltage of a determination-target cell group is equal to or lower than the threshold voltage that is obtained based on the average value and the standard deviation of the cell group voltages of a predetermined number of multiple cell groups that constitute a population. If it is determined that the cell group voltage of the determination-target cell group is equal to or lower than the threshold voltage, the determination unit 52 determines that a malfunction has occurred or a malfunction is about to occur in the determination-target cell group. If such a determination is made, it is possible to take measures promptly.

A concrete example will be described below. First, the determination unit 52 selects two or more cell groups from among multiple cell groups included in the fuel cell stack 10 to form a statistical population. The statistical population may be formed of any two or more cell groups among the cell groups in the fuel cell stack 10. Preferably, the cell groups that constitute the statistical population have the cell group voltages as high as possible, because this process is executed in order to detect a cell group of which the cell group voltage is dropping.

Therefore, the statistical population may be formed of the multiple cell groups other than the cell group having the lowest cell group voltage. Alternatively, the statistical population may be formed of the cell groups having the cell group voltages equal to or higher than the average cell group voltage. Further alternatively, the statistical population may be formed of a predetermined number of cell groups that are selected in the decreasing order of the cell group voltage from the cell group having the highest cell group voltage. In the embodiment, the statistical population is formed of the cell groups in the fuel cell stack 10 other than the cell group having the lowest cell group voltage.

The determination-target cell group may be any one of the cell groups in the fuel cell stack 10. Preferably, the cell group having a low cell group voltage is used as the determination-target cell group, because this process is executed in order to detect a cell group of which the cell group voltage is dropping. For example, the determination-target cell group is preferably the cell group having the cell group voltage equal to or lower than the average cell group voltage of the cell groups that constitute the fuel cell stack 10. In the embodiment, the cell group having the lowest cell group voltage is used as the determination-target cell group.

Next, the determination unit 52 calculates the average value X and the standard deviation σ of the cell group voltages of the cell groups in the statistical population. The determination unit 52 obtains the normal distribution curve as shown in FIG. 3 based on the average value X and the standard deviation σ. The determination unit 52 sets the threshold voltage Vd to the lower limit of the distribution range that is set based on the predetermined range (e.g. several times as large as the standard deviation σ) from the average value X. Next, the determination unit 52 determines that a malfunction has occurred or a malfunction is about to occur in the determination-target cell group, if the cell group voltage of the determination-target cell group is equal to or lower than the threshold voltage Vd. The relationship between the distribution range centered at the average value X and the risk rate is shown in Table 1. In the embodiment, the value that is obtained by subtracting 3σ from the average value X in the normal distribution is used as the threshold voltage Vd.

TABLE 1

| | Probability that each data | |
|---|---|---|
| Distribution range centered | falls within distribution | |
| at average value X | range | Risk rate |
| ±2σ | 95.44% | 2.28% |
| ±3σ | 99.74% | 0.16% |
| ±4σ | 99.994% | 0.002% |

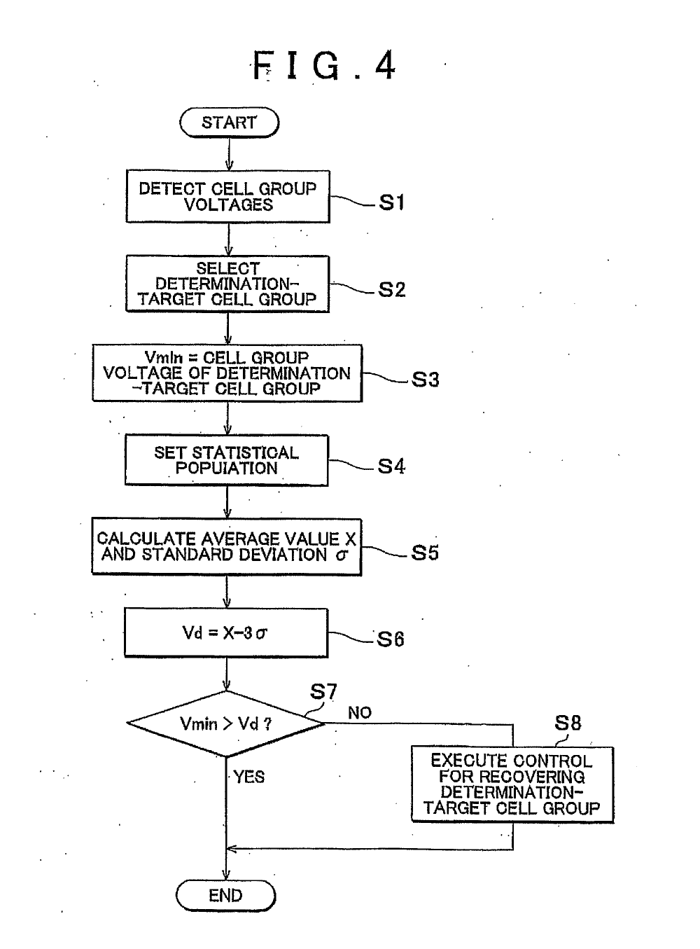

FIG. 4 shows an example of a flowchart for determining whether a malfunction has occurred in the determination-target cell group. As shown in FIG. 4, the voltage detection units 42 detect the cell group voltages of the respective cell groups (step (hereinafter, referred to as “S”) 1). Next, the determination unit 52 selects the determination-target cell group (S2). In the flowchart in FIG. 4, the determination unit 52 selects the cell group having the lowest cell group voltage as the determination-target cell group. Next, the determination unit 52 assigns the cell group voltage of the determination-target cell group to Vₘᵢₙ (S3).

Then, the determination unit 52 determines the cell groups that constitute the statistical population (S4). In the flowchart in FIG. 4, the determination unit 52 determines the cell groups other than the cell group that has the lowest cell group voltage as the cell groups that constitute the statistical population. Next, the determination unit 52 calculates the average value X and the standard deviation σ of the cell group voltages of the cell groups in the statistical population (S5). Next, the determination unit 52 calculates the threshold voltage Vd (S6). In the flowchart in FIG. 4, the value that is obtained by subtracting 3σ from the average value X is set to the threshold voltage Vd.

Next, the determination unit 52 determines whether Vₘᵢₙ is higher than the threshold voltage Vd (S7). If it is determined in S7 that Vₘᵢₙ is higher than the threshold voltage Vd, the routine ends. On the other hand, if it is determined in S7 that Vₘᵢₙ is equal to or lower than the threshold voltage Vd, the control unit 51 determine that a malfunction has occurred or a malfunction is about to occur in the determination-target cell group, and executes a control for recovering the determination-target cell group (S8). Then, the routine ends.

According to the flowchart in FIG. 4, it is possible to detect the cell group having the eccentric cell group voltage in the normal distribution of the cell group voltages of the cell groups in the statistical population. Thus, it is possible to detect the cell group in which a malfunction has occurred or a malfunction is about to occur.

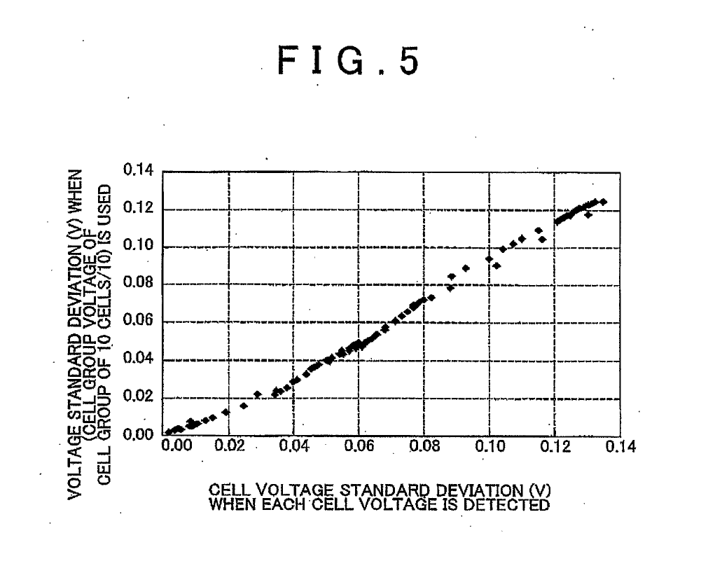

The comparison between the case where the cell voltage of each cell is detected and the case where the cell group voltage of each cell group is detected will be described below. FIG. 5 is a graph illustrating the relationship between the standard deviation when the cell voltage of each cell is detected and the standard deviation when the cell group voltage is divided by the number of cells in the cell group. In FIG. 5, the abscissa axis indicates the standard deviation of the cell voltages when the voltage of each cell is detected, and the ordinate axis indicates the standard deviation of the voltages when the value obtained by dividing the cell group voltage of each cell group formed of 10 cells by 10 is used. The data in FIG. 5 is obtained by using 400 cells as the target cells.

As shown in FIG. 5, the standard deviation of the cell voltages when the voltage of each cell is detected is substantially equal to the standard deviation of the voltages when the value obtained by dividing the cell group voltage of each cell group formed of 10 cells by 10 is used. Therefore, it is possible to determine whether a malfunction has occurred or a malfunction is about to occur on the cell group-by-cell group basis by detecting the cell group voltage of each cell group. Accordingly, it is no longer necessary to detect the cell voltage of each cell. Because the cell group voltage of each cell group is detected instead of detecting the cell voltage of each cell, the number of voltage detection units is reduced. As a result, the cost is reduced.

The determination unit 52 may exclude the cell group in which a malfunction has occurred or a malfunction is about to occur from the statistical population. In this case, even if the cell group voltages vary greatly due to temporal change, it is possible to suppress reduction in the accuracy of determination as to whether a malfunction has occurred or a malfunction is about to occur in the determination-target cell group. For example, if it is determined in S7 in the flowchart in FIG. 4 that the cell group voltage of the determination-target cell group is equal to or lower than the threshold voltage Vd, the determination unit 52 may exclude the determination-target cell group from the statistical population when the routine in the flowchart is executed next time.

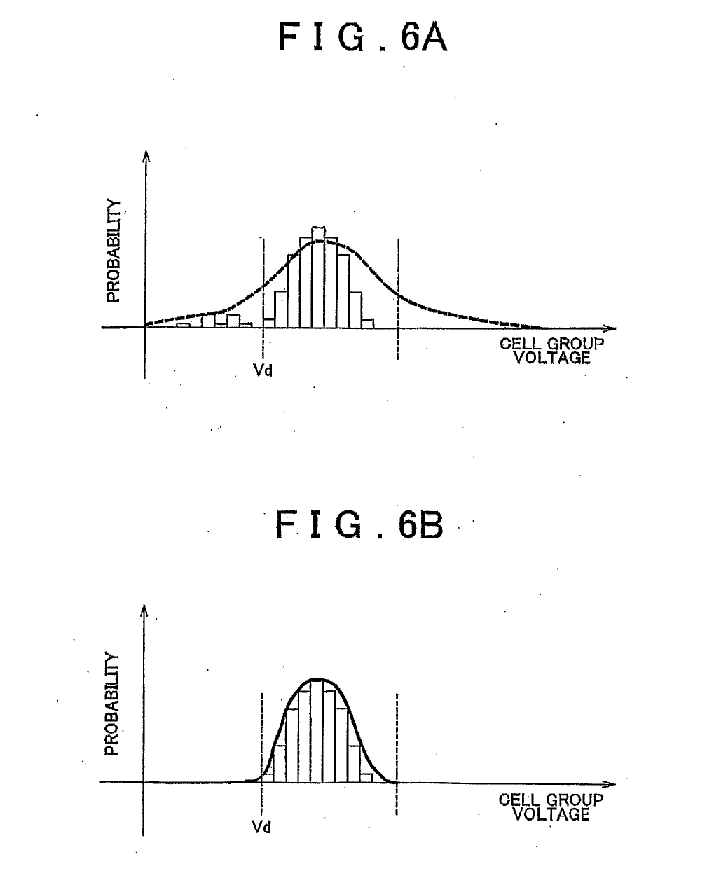

The determination unit 52 may exclude other cell groups having the cell group voltages equal to or lower than the threshold voltage Vd from the statistical population. If the average value X and the standard deviation σ are obtained based on the cell group voltages of the cell groups that include the cell groups having the cell group voltages equal to or lower than the threshold voltage Vd, the distribution indicated by the normal distribution curve is likely to be broad, as shown in FIG. 6A. Therefore, if the cell groups having the cell group voltages equal to or lower than the threshold voltage Vd are excluded from the statistical population, the distribution indicated by the normal distribution curve is narrow, as shown in FIG. 6B. In this case, it is possible to suppress reduction in the accuracy of determination as to whether a malfunction has occurred or a malfunction is about to occur in the determination-target cell group.

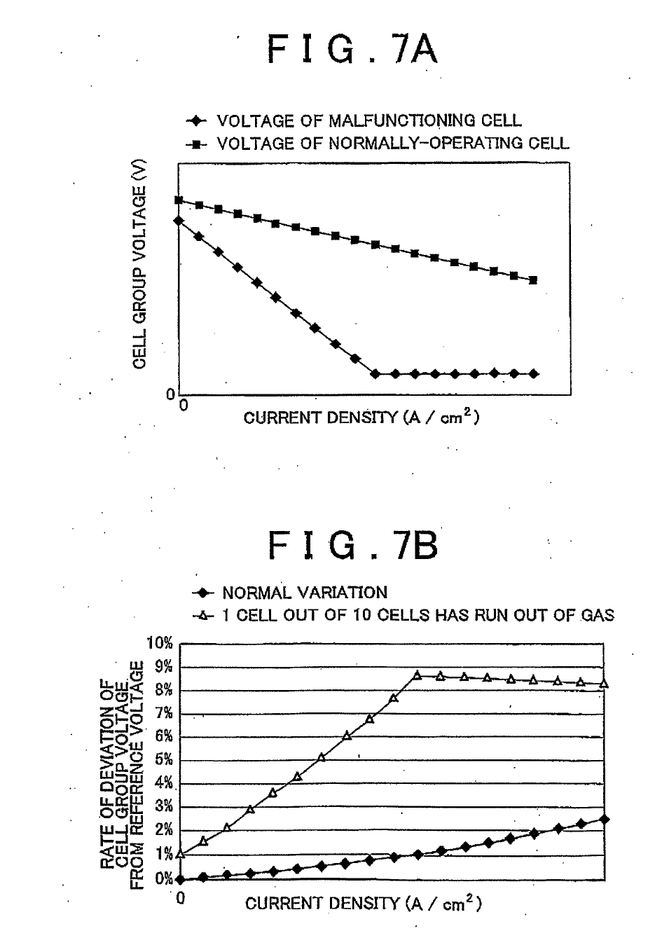

The determination unit 52 may exclude the cell group in which a change point, where the rate at which the cell group voltage changes with respect to the density of generated current changes, appears, from the statistical population. In this way, it is possible to exclude the cell group that has run out of, for example, oxygen or hydrogen from the statistical population. For example, as shown in FIG. 7A, in a normally-operating cell, the cell group voltage is likely to decrease linearly as the current density increases. In contrast, in a malfunctioning cell, for example, a cell that has run out of the reaction gas, the rate of decrease in the cell group voltage with respect to an increase in the current density is high, as shown in FIG. 7A. In addition, when the current density reaches a predetermined current density, the rate of decrease in the cell group voltage is decreased. The point at which the rate of change in the cell group voltage with respect to the current density changes is the change point. If the change point is detected, it is determined that a malfunction has occurred in the cell group, for example, the cell group has run out of the reaction gas.

FIG. 7B is a graph showing the relationship between the current density and the rate of deviation of the cell group voltage from the reference voltage (hereinafter, referred to as “deviation rate”). When the amount of reaction gas varies within the normal reaction gas amount range, the deviation rate increases as the current density increases, as shown in FIG. 7B. In contrast, in the cell group in which a malfunction has occurred, for example, in the cell group that has run out of the reaction gas, the deviation rate increases as the current density increases and the deviation rate starts decreasing at a predetermined value of current density, as shown in FIG. 7B. This value is detected as the change point. The deviation rate is expressed by Equation 1.

Deviation rate=(reference voltage−cell group voltage of target cell group)/reference voltage×100% Equation 1

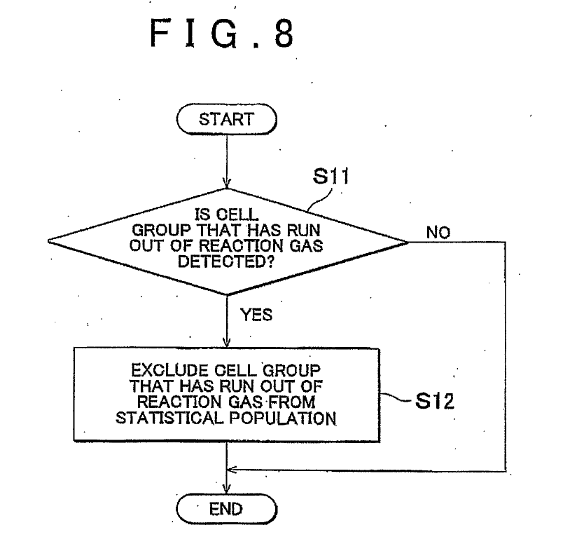

FIG. 8 is an example of a flowchart showing a routine that is executed when cell groups that constitute the statistical population are changed. As shown in FIG. 8, the determination unit 52 determines whether the cell group that has run out of the reaction gas, for example, hydrogen is detected (S11). In S11, the determination unit 52 determines, for example, whether there is detected the cell group in which a change point, where the rate at which the cell group voltage changes with respect to the current density changes, appears as shown in FIG. 7A or FIG. 7B.

If it is determined in S11 that the cell group that has run out of, for example, the reaction gas is detected, this cell group is excluded from the statistical population (S12). Then, the determination unit 52 ends the routine according to the flowchart in FIG. 8. According to the flowchart in FIG. 8, it is possible to exclude the cell group that has run out of, for example, the reaction gas from the statistical population. Thus, the accuracy of the determination on the determination-target cell group improves.

The determination unit 52 may exclude a certain cell group from the statistical population based on the constituent concentration in the cathode offgas or the anode offgas. For example, the determination unit 52 may exclude the cell group in which the concentration of hydrogen in the cathode offgas exceeds a reference value and the cell group in which the concentration of CO or CO₂ exceeds a reference value from the statistical population. The determination unit 52 may exclude the cell group in which the concentration of O₂ in the anode offgas exceeds a reference value and the cell group in which the concentration of CO or CO₂ in the anode offgas exceeds a reference value from the statistical population. In this way, the accuracy of the determination on the determination-target cell group improves.

In addition, when the absolute value of the skewness √b₁ of the normal distribution is lower than a predetermined value (e.g. 1.5), the determination unit 52 may increase the number of cell groups that constitute the statistical population. In this case, the statistical population forms the normal distribution more easily. The skewness √b₁ is expressed by Equation 2.

√b₁=(Σ(Xi−X)³/n×σ³ Equation 2
Xi: cell group voltage of each cell group n: the number of data

It is possible to improve the reliability of the statistical population by changing the cell groups that constitute the statistical population as described above. Even if the state of the fuel cell stack 10 changes due to, for example, temporal change, it is possible to maintain the reliability of the statistical population. As a result, the accuracy of the determination on the determination-target cell group improves.

1. A fuel cell system, comprising:
a fuel cell stack that is formed by stacking a plurality of cell groups each of which includes at least one cell;
voltage detection units that detect cell group voltages of the respective cell groups; and
a determination unit that determines whether the cell group voltage of a determination-target cell group that is selected from among the plurality of cell groups is equal to or lower than a threshold voltage that is obtained based on an average value and a standard deviation of the cell group voltages of the cell groups in a population that is formed of at least two of the cell groups among the plurality of cell groups,
wherein the determination-target cell group has the lowest cell group voltage among the plurality of cell groups, and
wherein the population does not include the determination-target cell group.

2. The fuel cell system according to claim 1, further comprising:
a control unit that controls the fuel cell system, wherein
if the determination unit determines that the cell group voltage of the determination-target cell group is equal to or lower than the threshold voltage, the control unit determines that a malfunction has occurred or a malfunction is about to occur in the determination-target cell group.

3.-5. (canceled)

6. The fuel cell system according to claim 1, wherein the population is formed of a predetermined number of cell groups that are selected in a decreasing order of the cell group voltage from the cell group having the highest cell group voltage.

7. The fuel cell system according to claim 1, wherein the threshold voltage is a lower limit of a predetermined range centered at the average value of the cell group voltages of the cell groups in the population, the predetermined range being determined based on a normal distribution of the cell group voltages of the cell groups in the population.

8. The fuel cell system according to claim 1, wherein the determination unit excludes the cell group having the cell group voltage equal to or lower than a predetermined cell group voltage from the population.

9. The fuel cell system according to claim 1, wherein the determination unit excludes, from the population, the cell group having the cell group voltage equal to or lower than a lower limit of a predetermined range centered at the average value of the cell group voltages of the cell groups in the population, the predetermined range being determined based on a normal distribution of the cell group voltages of the cell groups in the population.

10. The fuel cell system according to claim 1, wherein the determination unit excludes, from the population, the cell group in which a change point, where a rate at which the cell group voltage changes with respect to a density of generated current changes, appears.

11. The fuel cell system according to claim 1, wherein the determination unit excludes, from the population, the cell group in which a change point, where a rate at which a rate of deviation of the cell group voltage from a reference voltage changes with respect to a density of generated current changes, appears.

12. The fuel cell system according to claim 1, wherein the determination unit excludes a certain cell group from the population based on a constituent concentration in cathode offgas or anode offgas.

13. The fuel cell system according to claim 1, wherein the determination unit increases the number of cell groups that constitute the population when an absolute value of a skewness of a normal distribution of the cell group voltages of the cell groups in the population is lower than a predetermined value.

14. A method for detecting a state of a fuel cell having a fuel cell stack that is formed by stacking a plurality of cell groups each of which includes at least one cell, comprising:
detecting cell group voltages of the respective cell groups; and
determining whether the cell group voltage of a determination-target cell group that is selected from among the plurality of cell groups is equal to or lower than a threshold voltage that is obtained based on an average value and a standard deviation of the cell group voltages of the cell groups in a population that is formed of at least two of the cell groups among the plurality of cell groups,
wherein the determination-target cell group has the lowest cell group voltage among the plurality of cell groups, and
wherein the population does not include the determination-target cell group.

15.-17. (canceled)

18. The method according to claim 14, wherein the threshold voltage is a lower limit of a predetermined range centered at the average value of the cell group voltages of the cell groups in the population, the predetermined range being determined based on a normal distribution of the cell group voltages of the cell groups in the population.

19. The method according to claim 14, wherein the cell group having the cell group voltage equal to or lower than a predetermined cell group voltage is excluded from the population.

20. The method according to claim 14, wherein the cell group having the cell group voltage equal to or lower than a lower limit of a predetermined range centered at the average value of the cell group voltages of the cell groups in the population is excluded from the population, the predetermined range being determined based on a normal distribution of the cell group voltages of the cell groups in the population.
